(19) United States
(12) Patent Application Publication
(10) Pub. No.: US 2020/0023459 A1
(43) Pub. Date: Jan. 23, 2020

(54) Method Of Coating A Workpiece, Workpiece, Coating Machine, And Use Of A Friction-Welding Apparatus

(71) Applicants: TE Connectivity Germany GmbH, Bensheim (DE); Technical University of Ilmenau, Ilmenau (DE)

(72) Inventors: Uwe Hauck, Kleinmanchow (DE); Helge Schmidt, Speyer (DE); Jean Pierre Bergmann, Erfurt (DE); Anna Regensburg, Waltenhofen-Memhölz (DE)

(73) Assignees: TE Connectivity Germany GmbH, Bensheim (DE); Technical University of Ilmenau, Ilmenau (DE)

(21) Appl. No.: 16/516,852

(22) Filed: Jul. 19, 2019

(30) Foreign Application Priority Data
Jul. 20, 2018 (DE) 102018212156.7

(51) Int. Cl. B23K 20/12; B23K 1/20; B23K 35/02

(52) U.S. Cl. CPC B23K 20/1215; B23K 1/20; B23K 2103/12; B23K 35/0261; B23K 20/129

(57) ABSTRACT

A method for coating a workpiece includes a step of applying a coating material to the workpiece and a step of friction welding the coating material to the workpiece.

### CROSS-REFERENCE TO RELATED APPLICATION

This application claims the benefit of the filing date under 35 U.S.C. § 119(a)-(d) of German Patent Application No. 102018212156.7, filed on Jul. 20, 2018.

### FIELD OF THE INVENTION

The present invention relates to a workpiece and, more particularly, to coating a workpiece.

### BACKGROUND

In order to secure a contact element to a workpiece, attachment using an ultrasound welding method, for example, is known. Joining by welding or soldering is also possible. With soldering, under some circumstances, it is necessary to pretreat the surface of the workpiece, such as with chemicals. The pre-treatment process can be laborious.

### SUMMARY

A method for coating a workpiece includes a step of applying a coating material to the workpiece and a step of friction welding the coating material to the workpiece.

### BRIEF DESCRIPTION OF THE DRAWINGS

The invention will now be described by way of example with reference to the accompanying Figures, of which:

FIG. 1 is a schematic side view of a method for coating a workpiece according to an embodiment;

FIG. 2 is a side view of the workpiece with a coating and a further coating;

FIG. 3 is a schematic side view of the workpiece with the coating attached to a contact element;

FIG. 4 is a schematic side view of the workpiece with the coating attached to another contact element;

FIG. 5 is a schematic side view of a method for coating a workpiece according to another embodiment; and

FIG. 6 is a schematic side view of a method for coating a workpiece according to another embodiment.

### DETAILED DESCRIPTION OF THE EMBODIMENT(S)

Embodiments of the present invention will be described hereinafter in detail with reference to the attached drawings, wherein like reference numerals refer to like elements. The present invention may, however, be embodied in many different forms and should not be construed as being limited to the embodiments set forth herein; rather, these embodiments are provided so that the disclosure will convey the concept of the invention to those skilled in the art. The developments and configurations depicted in the embodiments are each independent of one another and can be combined with one another as desired, depending on the specific application.

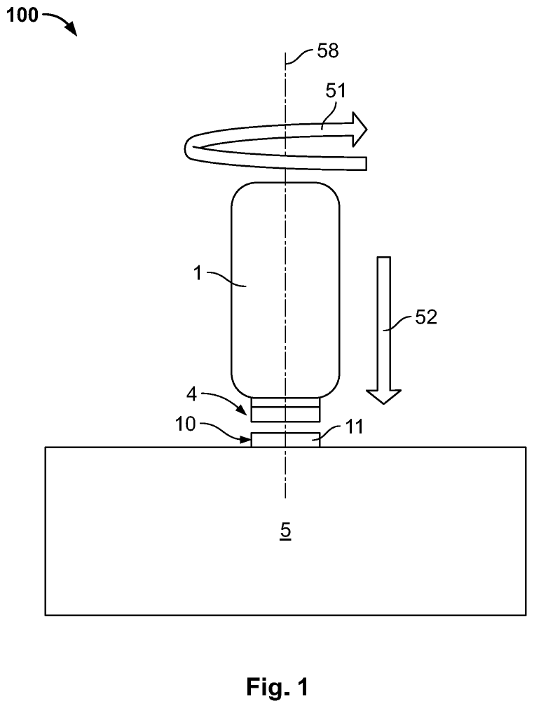

A method for coating a workpiece 5 according to an embodiment is shown in FIG. 1. The workpiece 5 can be an electrical component, for example, a contact element or a different conducting element. The workpiece 5 can also fulfil a mechanical function. The workpiece 5 can consist of, in particular, a material such as magnesium, aluminum or titanium, or alloys with at least one of these elements.

The workpiece 5 is intended to be coated with a coating material 10, as shown in FIG. 1, which has been applied, for example, in a previous step. In various embodiments, the coating material 10 can comprise higher- or lower-melting materials than the workpiece 5. In various embodiments, the coating material 10 can comprise copper, nickel, gold, silver, palladium, tin, zinc, antimony, tellurium, bismuth, phosphorous, cadmium, germanium, and alloys of these metals. The coating material 10 is a solderable material. In an embodiment, the coating material 10 can be a contact material that makes an electrically releasable contacting possible. In an embodiment, the coating material 10 can be a bondable material, such as pure aluminum, gold, nickel, and/or silver.

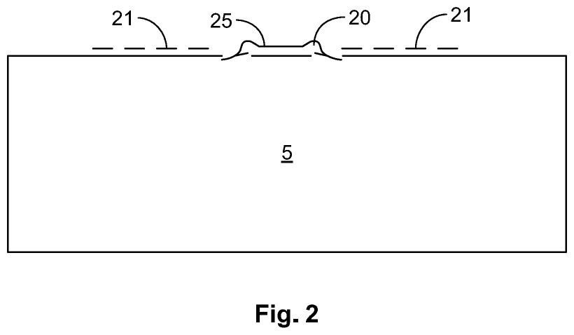

In the embodiment shown in FIG. 1, the coating material 10 is configured as a foil or a sheet 11, which has been punched from a larger sheet, for example. In another embodiment, the foil or sheet 11 can be pre-manufactured. After placement onto the workpiece 5, a friction body 1 of a coating machine 100 is pressed along a press-on direction 52 onto the coating material 10. In this case, the friction body 1 rotates along a rotation direction 51 around a rotation axis 58, as a result of which heat arises at a tip 4 of the friction body 1 and in the coating material 10 and also at a surface of the workpiece 5. In an embodiment, an oscillating, rotational, or linear movement of the friction body 1 can be used. This leads to a fusion between the coating material 10 and the workpiece 5. The coating material 10 is welded to the workpiece 5 in the manner of the friction weld or friction stir weld and forms a coating 20 on the workpiece 5, as shown in FIG. 2.

The coating machine 100, which is depicted only schematically and partially in FIG. 1, can have a drive for the friction body 1, a press-on device for the friction body 1, a positioning device for the coating material 10, a feed mechanism for the coating material 10, and further elements.

The coating 20 produced by the method of FIG. 1 is shown in FIG. 2. The coating 20 is arranged only on a partial region of a surface of the workpiece 5; in an embodiment, the coating material 10 is friction welded selectively to the workpiece 5. In the immediate vicinity of the coating 20, there is a further coating 21 which can be produced using the same method as shown in FIG. 1. The further coating 21 can have different properties and can comprise a different material than the coating material 10. In an embodiment, the coating 20 can be laid out for good contacting and can form a solderable area 25. The solderable area 25 can additionally contain materials such as tin, zinc, silver, gold, or lead and can ensure that the production of a soldered joint is made possible or improved at this location. The further coating 21 can ensure that there is corrosion resistance. Potentially interfering layers, such as oxide layers, can be chemically altered during the generation of the solderable area 25, for example can be reduced, or mechanically broken up or removed, in order to make good contact possible.

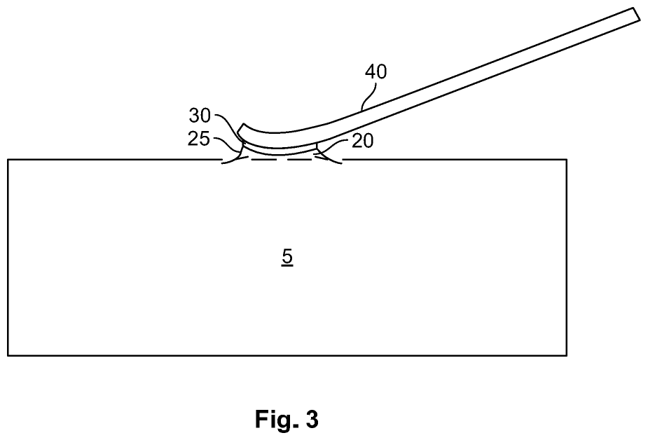

A contact element 40 soldered to the workpiece 5 at the coating 20 is shown in FIG. 3. In the shown embodiment, a solder 30 serves for the joint. The coating 20 makes a simple brazing of the contact element 40 possible, without the workpiece 5 having to be pretreated with chemicals.

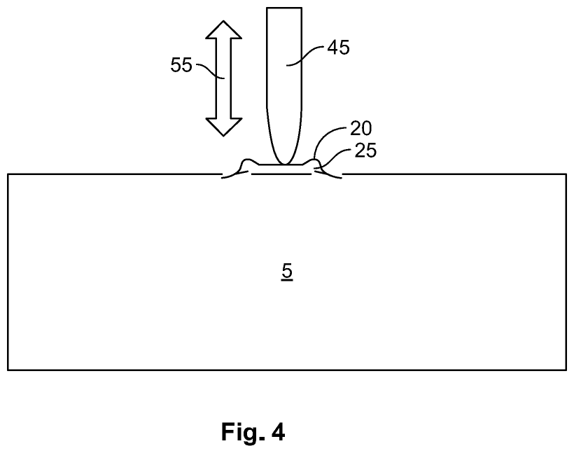

A releasable contacting of the workpiece 5 with a contact element 45 is shown in FIG. 4. The contact element 45 is brought along a contact direction 55 onto the coating 20. Here, the coating 20 can ensure that there is low, reproducible transition resistance between the contact element 45 and the workpiece 5.

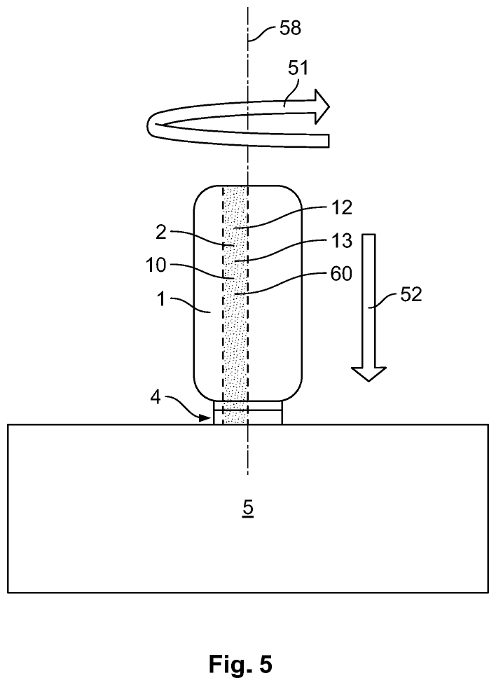

In another embodiment of coating the workpiece 5, shown in FIG. 5, the coating material 10 is fed as a powder 12 or a slurry 13. An amount of such a slurry 13 can be dosed, for example, so that different amounts can easily be applied for different applications. The slurry 13 can be viscous and pasty, so that simple positioning is possible. The slurry 13 can also be more runny and thus make application, for example via fluid lines, possible.

As shown in FIG. 5, a feed channel 2 is present in the friction body 1, and the feed channel 2 leads to the tip 4 of the friction body 1. The coating material 10 can emerge from the feed channel 2 and can be welded to the workpiece 5 by way of the friction body 1. The feed channel 2 can, in an embodiment, be arranged asymmetrically in the friction body 1, so that the feed channel 2 rotates around the rotation axis 58 during a rotation. In this way, the fed coating material 10 enters automatically into a pressing region with a pressing surface, and thus can be heated. The feed channel 2 can thus, in an embodiment, not be concentric with the rotation axis 58. The method of FIG. 5 includes a step in which the coating material 10, similarly to what happens in the friction welding or friction stir welding, is heated by a rotation of a tool, namely the friction body 1, and is fused to, or blended, or diffused with the workpiece 5. In an embodiment, the coating machine 100 has a dosing device for powder or fluid material that, for example, can include tubes or channels for powder or fluid material.

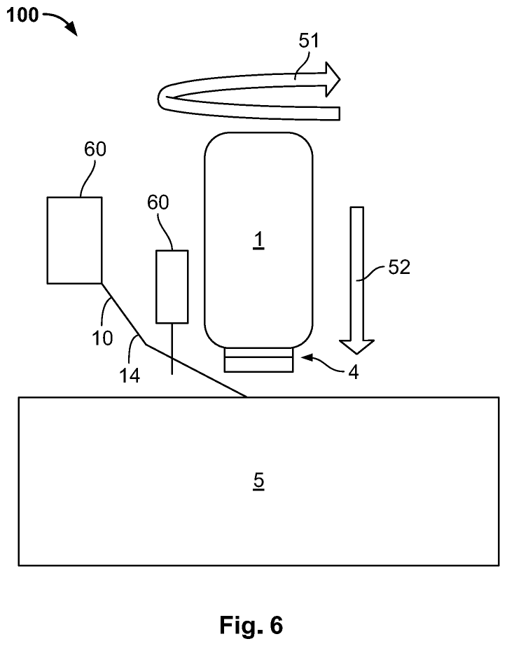

In another embodiment of coating the workpiece 5, as shown in FIG. 6, the coating material 10 is fed in the shape of a wire 14. In the shown embodiment, the coating machine 100 includes a feed device 60, which feeds the wire 14 to the desired coating location.

In the methods for coating the workpiece 5 described above, it is not necessary to pretreat the surface of the workpiece 5. The coating material 10 is pressed with high pressure and with friction onto the workpiece 5. By way of the friction arising during the method, the coating material 10 is joined to the workpiece 5 by blending of the materials and diffusion. The coating technique according to the invention can also be used in particular for the selective coating of small regions.

The methods for coating the workpiece 5 described above can be employed to produce different coatings at different locations, in particular at neighboring locations on the workpiece 5. For example, at a first location, the coating 20 can be produced which is suitable for contacting. In an adjacent region, which can enclose the first region in particular, an anti-corrosion coating can be applied, for example, or a coating which protects against mechanical damage.

What is claimed is:

1. A method for coating a workpiece, comprising:
applying a coating material to the workpiece; and
friction welding the coating material to the workpiece.

2. The method of claim 1, wherein the coating material is applied as a powder.

3. The method of claim 1, wherein the coating material is applied as a foil or a sheet.

4. The method of claim 1, wherein the coating material is applied as a slurry.

5. The method of claim 1, wherein the coating material is applied as a wire.

6. The method of claim 1, wherein the coating material is fed through a friction body in the applying step.

7. The method of claim 1, wherein the workpiece is aluminum, magnesium, titanium, or an alloys of these materials.

8. The method of claim 1, wherein the coating material is friction welded selectively to the workpiece.

9. The method of claim 1, wherein the friction welding step forms a solderable area on the workpiece.

10. A workpiece, comprising:
a coating including a coating material friction welded to the workpiece.

11. The workpiece of claim 10, wherein the workpiece is aluminum, magnesium, titanium, or an alloys of these materials.

12. The workpiece of claim 11, wherein the coating material is copper, nickel, gold, silver, palladium, tin, zinc, antimony, tellurium, bismuth, phosphorous, cadmium, germanium, or an alloys of these metals.

13. The workpiece of claim 10, wherein the coating material is a different material than a material of the workpiece.

14. The workpiece of claim 10, wherein the coating material has a different melting temperature than a material of the workpiece.

15. A coating machine, comprising:
a friction body for coating a workpiece with a coating material.

16. The coating machine of claim 15, further comprising a feed device feeding the coating material to the workpiece.

17. The coating machine of claim 15, wherein the friction body has a feed channel for the coating material.

18. The coating machine of claim 15, wherein the friction body rotates about a rotation axis to friction weld the coating material to a surface of the workpiece.
